(19) United States
(12) Patent Application Publication
(10) Pub. No.: US 2008/0266169 A1
(43) Pub. Date: Oct. 30, 2008

(54) RADAR DEVICE

(75) Inventor: Kenichi AKITA, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI ELECTRIC CORPORATION, Tokyo (JP)

(21) Appl. No.: 11/842,278

(22) Filed: Aug. 21, 2007

(30) Foreign Application Priority Data
Apr. 27, 2007 (JP) 2007-119643

(51) Int. Cl. G01S 13/00; B60R 21/00

(52) U.S. Cl. 342/73; 342/117

(57) ABSTRACT

A radar device capable of detecting a target object by itself only in a range required by a vehicle control system by changing the detection angle depending on the distance without changing the hardware structure is provided. The radar device includes transmitting means for transmitting an electromagnetic wave as a transmission signal, receiving means for receiving the electromagnetic wave reflected from the target object as a reception signal, and signal processing means for detecting a target object existing around the vehicle from the transmission signal and the reception signal, and calculating the relative position and the relative speed between the object and the vehicle. The detection angle is changed depending on the distance for measurement, so that the target object is detected only in a region necessary in operating the vehicle control system.

### BACKGROUND OF THE INVENTION

1. Field of the Invention

The present invention relates to a radar device provided in a vehicle to detect a target object existing around the vehicle and measure the relative position and the relative speed between the vehicle and the object.

2. Description of the Related Art

A radar device provided in a vehicle transmits an electromagnetic wave as a transmission signal, receives the electromagnetic wave reflected by a target object as a reception signal, and measures the relative position and the relative speed between the vehicle and the target object based on the transmission signal and the reception signal. The radar device is used in a vehicle control system such as a following distance control system used to control the distance between the vehicle and the preceding vehicle and a jam tracking system that allows the vehicle to follow the preceding vehicle during a traffic jam.

Such a vehicle control system must generally detect a vehicle coming to cut in from an adjacent lane at a relatively short distance. Therefore, in the short distance, a wide detection angle range is necessary so that vehicles moving in adjacent lanes can be detected. Meanwhile, a target object existing at a relatively long distance must be detected to control the following distance mainly when the vehicle travels at high speed, and a detection angle range as wide as that in the short distance is not necessary. More specifically, depending on the distance for measuring, the detection angle range required by the vehicle control system varies. Therefore, if the detection angle range is widened in the short distance region, detection operation for a target object in the long distance region is carried out in a detection angle range wider than necessary.

Therefore, a vehicle control system as disclosed by JP-A-2002-6041 includes two kinds of transmitting means for short and long distances, so that the detection angle range is changed between the short distance and the long distance.

However, the radar device disclosed by JP-A-2002-6041 must also include transmitting means for both short and long distances, which increases the size of the hardware structure and the cost accordingly.

### SUMMARY OF THE INVENTION

The present invention is directed to a solution to the above-described disadvantages and it is an object of the invention to provide a radar device capable of detecting a target object by itself only in a range needed by a vehicle control system by changing the detection angle range depending on the distance without changing the hardware structure.

A radar device according to the invention is provided in a vehicle to detect a target object existing around the vehicle and includes transmitting means for transmitting an electromagnetic wave as a transmission signal, receiving means for receiving the electromagnetic wave reflected from the target object as a reception signal, and signal processing means for detecting the target object based on the transmission signal and the reception signal and measuring the relative position and the relative speed between the vehicle and the object. The radar device changes the detection angle range for the target object depending on the distance from the vehicle by the signal processing means without changing the transmitting means and the receiving means.

According to the invention, a single radar device is capable of detecting a target object in different detection angle ranges depending upon the distance without changing its hardware structure.

The foregoing and other objects, features, aspects, and advantages of the present invention will become more apparent from the following detailed description of the present invention when taken in conjunction with the accompanying drawings.

### BRIEF DESCRIPTION OF THE DRAWINGS

FIG. 1 is a schematic block diagram of a radar device according to a first embodiment of the invention;

FIGS. 2A to 2C are charts showing the relation between a transmission pulse and a reception pulse with time and sampling timing;

FIG. 3 is a view showing transmission beams and reception beams;

FIG. 4 is a view showing a region in which a target object should be detected in a short distance region;

FIG. 5 is a view showing a region in which a target object should be detected in a long distance region;

FIG. 6 is a view showing unnecessary detection regions;

FIG. 7 is a view showing a detection region when the detection angle range is changed between a short distance region and a long distance region;

FIG. 8 is a view showing beams used to detect a target object in the short distance region;

FIG. 9 is a view showing beams used to detect a target object in the long distance region;

FIG. 10 is a view showing the detection range when the beams used for detecting a target object are changed between the short distance region and the long distance region;

FIG. 11 is a flowchart for use in illustrating signal processing according to the first embodiment;

FIG. 12 is a view showing a detection region when the detection angle range is gradually changed;

FIG. 13 is a flowchart for use in illustrating signal processing according to a second embodiment; and

FIG. 14 is a schematic block diagram showing the structure of a radar device according to a third embodiment of the invention.

### DETAILED DESCRIPTION OF THE PREFERRED EMBODIMENTS

### First Embodiment

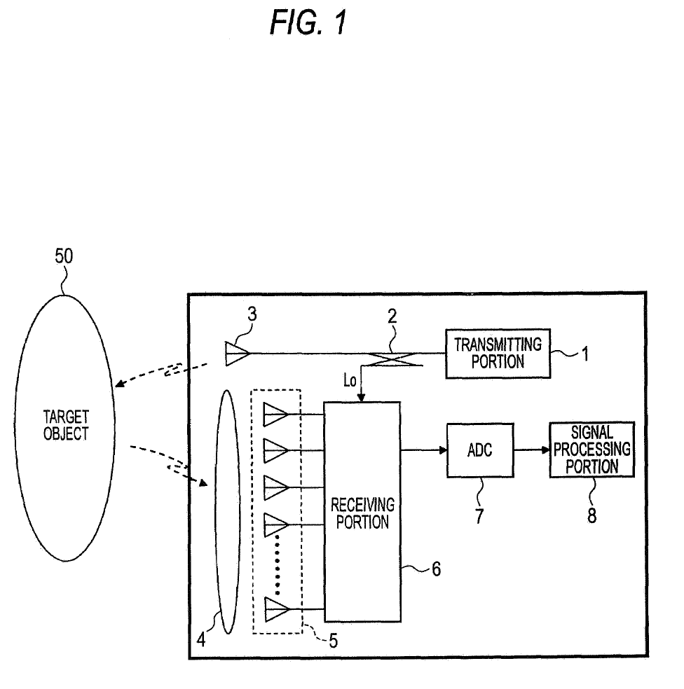

FIG. 1 is a schematic block diagram of the structure of a pulse type radar device according to a first embodiment of the invention.

The radar device 10 includes a transmitting portion 1 that outputs a pulse-modulated electromagnetic wave as a transmission signal, a directional coupler 2 that branches the output of the transmitting portion 1 into two, and a transmitting antenna 3 that radiates the output of the directional coupler 2 into the space.

The radar device 10 also includes a receiving antenna portion 5 including a plurality of antennas that receive the electromagnetic wave reflected by a target object 50 as a reception signal, a lens 4 that forms the reception beam width and direction of each antenna in the receiving antenna portion 5, and a receiving portion 6 that mixes the reception signal received by the receiving antenna portion 5 and a local signal Lo transmitted from the directional coupler 2 and extracts a beat signal.

The radar device 10 also includes an A/D converter 7 that converts the beat signal output from the receiving portion 6 into a digital signal and a signal processing portion 8 that detects the target object 50 based on the output signal of the A/D converter 7 and calculates its relative position and its relative speed.

Now, the transmitting and receiving operation will be described.

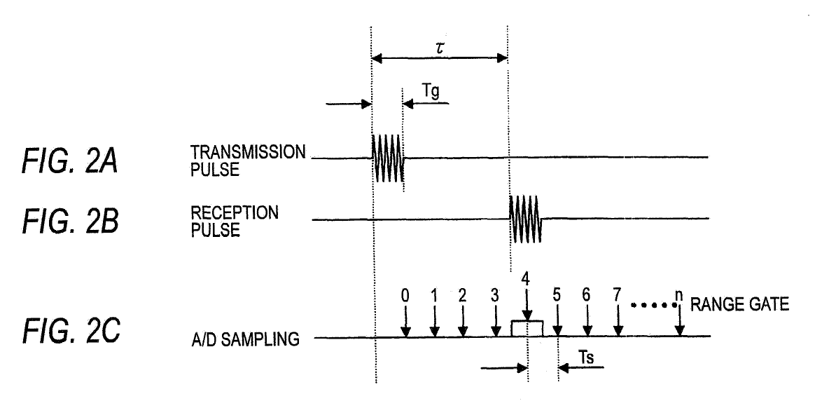

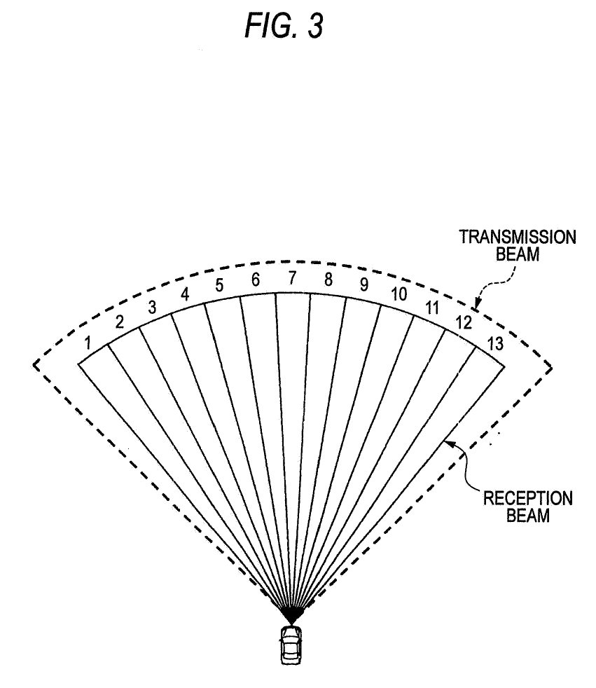

The transmitting portion 1 outputs a pulse-modulated electromagnetic wave as shown in FIG. 2A. The signal output from the transmitting portion 1 is branched into signals for transmission and reception by the directional coupler 2, the former is radiated into the space through the transmitting antenna 3 and the latter is input to the receiving portion 6 as the local signal Lo. The electromagnetic wave radiated from the transmitting antenna 3 is reflected by the target object 50 existing in front of the radar and received by the receiving antenna portion 5 through the lens 4. Then, as shown in FIG. 3, a plurality of reception beams are formed by the lens 4 and the reception antenna portion 5. As shown in FIG. 2B, the reception signal is received with a time delay of τ seconds represented by the following Expression (1) after the transmission of the electromagnetic wave because of the distance of the target object.

$$τ = \frac{2 R}{c} \qquad ( 1 )$$

where R is the distance of the target object, and c[m/s] is light velocity.

The reception signal received by the receiving antenna portion 5 is mixed with the local signal Lo from the transmitting portion 1 at the receiving portion 6 and a beat signal is output. The A/D converter 7 converts the beat signal output from the receiving portion 6 into a digital signal.

As shown in FIG. 2C, in the A/D converter 7, sampling is carried out n times at sampling intervals of Ts[m]. The n sampling points are referred to as “range gates.” The distance range of the target object that can be detected at each range gate is determined based on the pulse width Tg[sec] and the sampling interval Ts [sec], and each of the range gates can receive only a reception signal from the target object existing in the distance range.

The signal of each range gate sampled by the A/D converter 7 is input to the signal processing portion 8. The signal processing portion 8 detects the target object based on the beat signal output from the A/D converter 7 and calculates its relative position/relative speed.

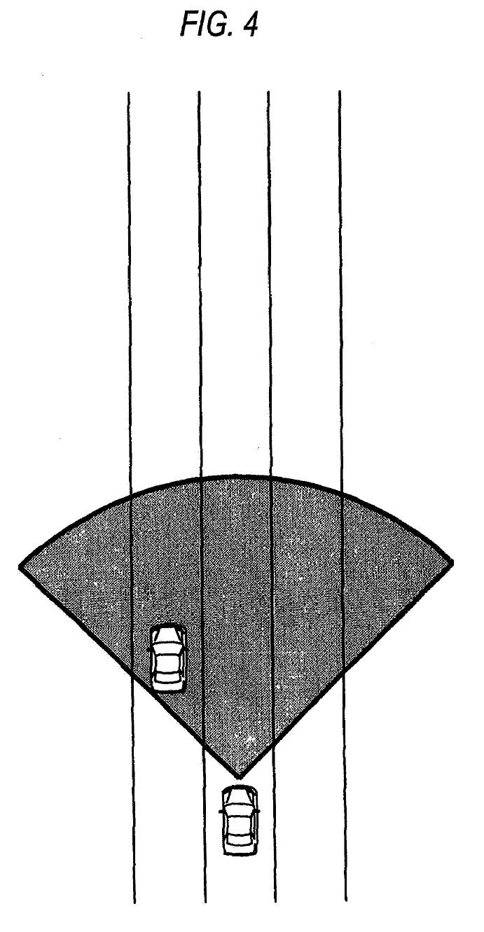

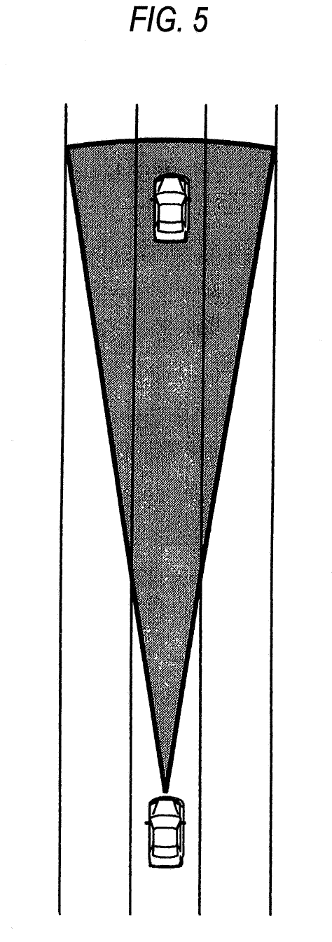

Herein, the vehicle control system needs a wide detection range in a relatively short distance region as shown in FIG. 4. On the other hand, the system does not need a detection angle as wide as that in a relatively long distance region and as shown in FIG. 5, it is only necessary that the target object can be detected with a relatively narrow detection angle.

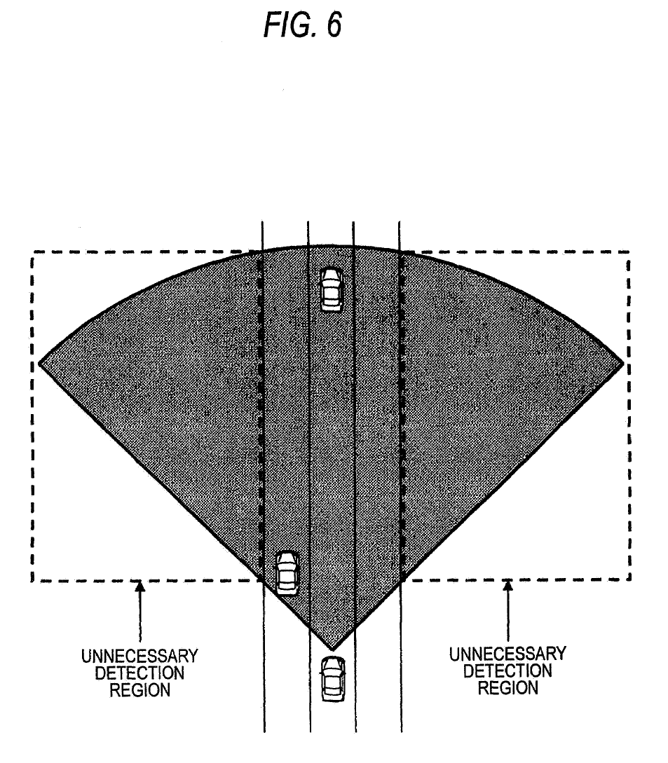

If, however, the number of reception beams is increased in order to widen the detection angle range in the short distance, the detection region in the long distance region is unnecessarily widened as shown in FIG. 6. Therefore, unnecessary detection operation for the target object would be carried out in the region unnecessary for the vehicle control system.

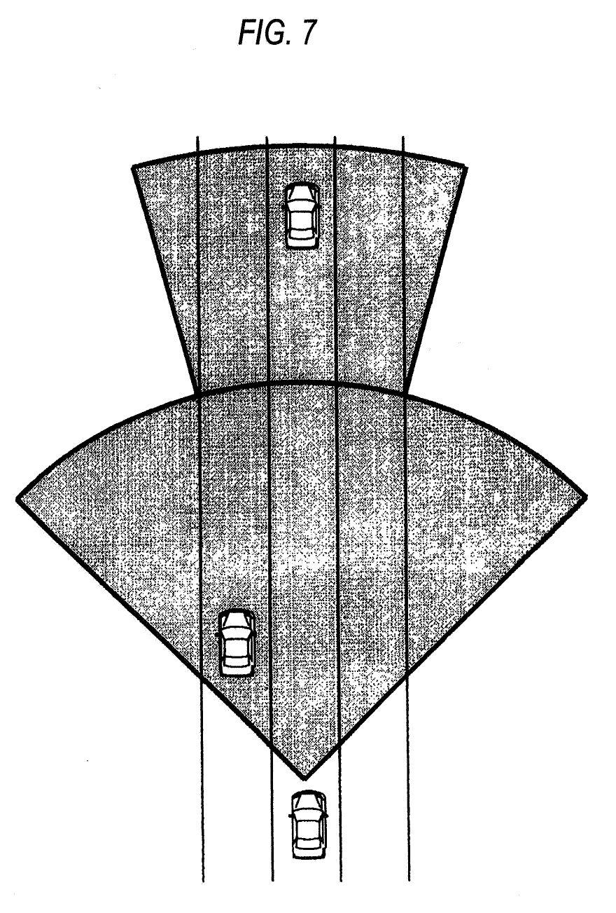

Therefore, using a prescribed range gate as a boundary, the detection range is divided into a short distance region and a long distance region, and as shown in FIG. 7, the detection angle range is smaller in the long distance region than in the short distance region, so that the target object can be detected only in the range necessary for the vehicle control system.

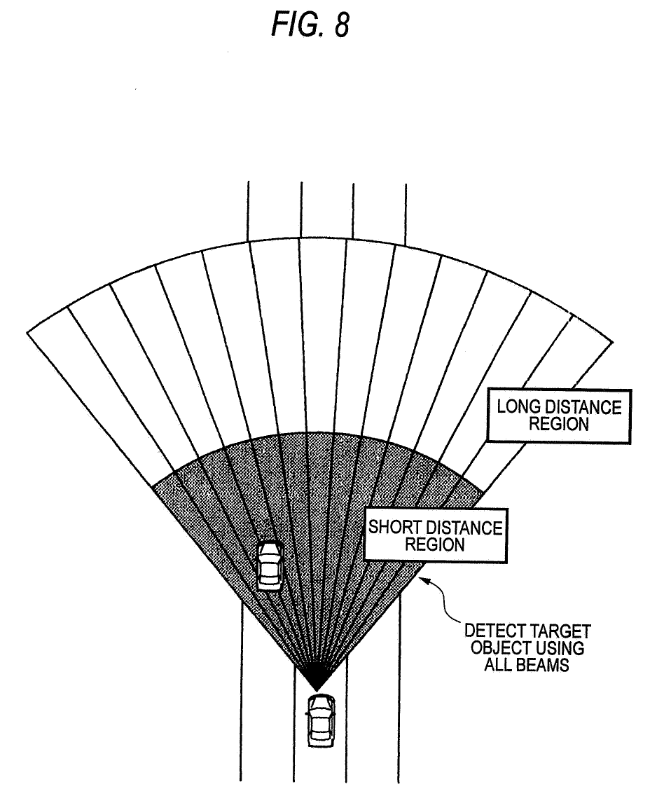

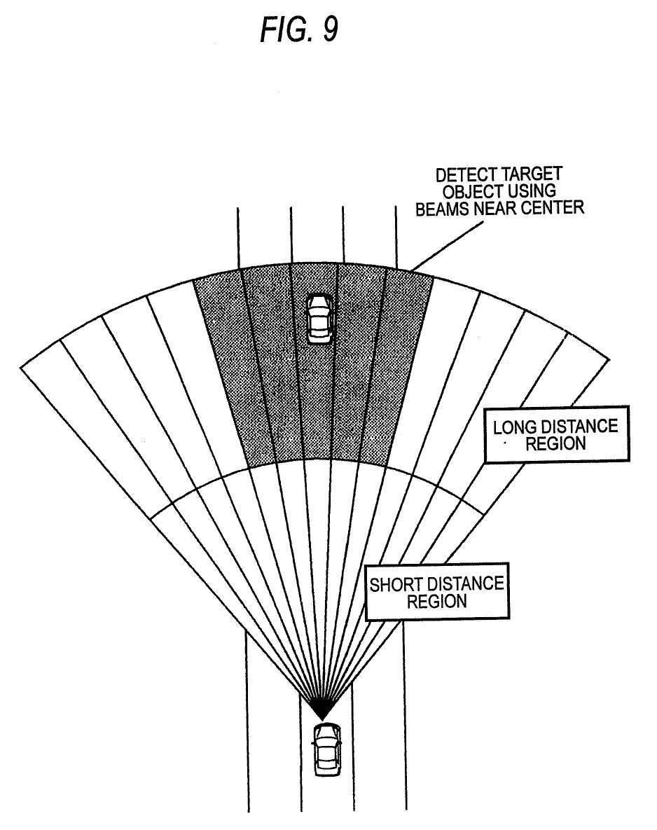

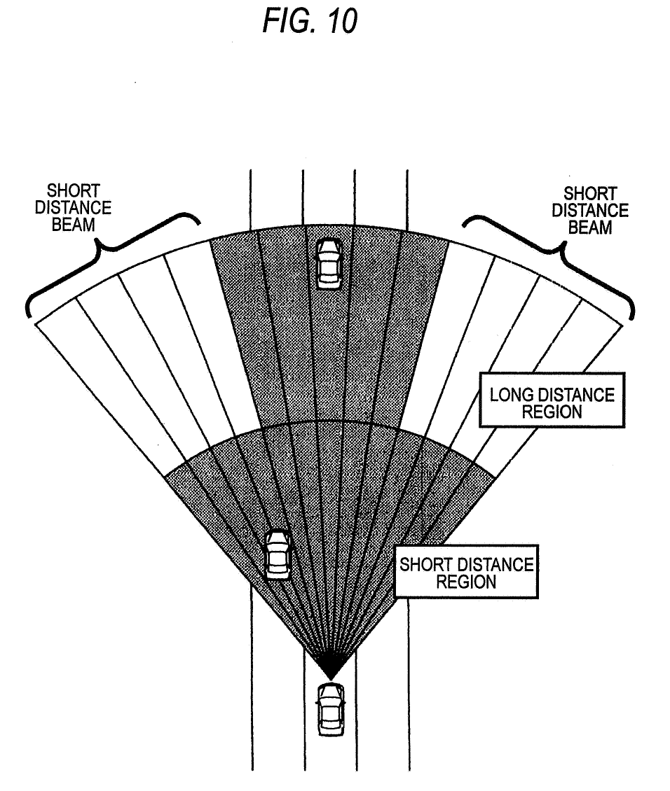

Now, as shown in FIG. 3, an example of forming reception beams in 13 directions will be described. In the short distance region, a wide detection angle range is necessary, and therefore all the beams 1 to 13 are used to detect the target object as shown in FIG. 8. On the other hand, in the long distance region, a detection angle range as wide as that in the short distance region is not necessary, and therefore four beams each at both ends (hereinafter defined as “short distance beams”) are not used to detect the target object and the target object is detected only with the five beams in the center as shown in FIG. 9. In this way, in the long distance region, the number of beams to be used to detect the target object is limited, so that the target object can be detected only in the region necessary for the vehicle control system as shown in FIG. 10.

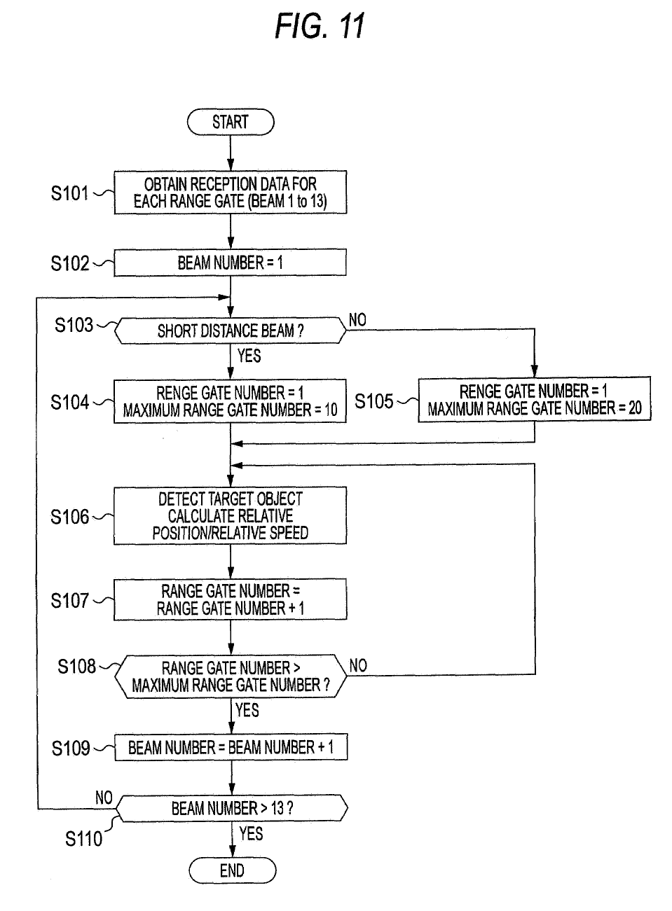

In the following paragraphs, processing operation in the signal processing portion 8 will be described with reference to the signal processing flowchart in FIG. 11. In the following description, the number of range gates is 20, a region having 10 range gates or less is referred to as “short distance region,” and a region having 11 to 20 range gates is referred to as “long distance region.”

To begin with, in step S101, the reception data of beams 1 to 13 is obtained for each range gate, and in step S102, a beam to be processed first is labeled number 1. Then, it is determined in S103 whether the beam being processed at present is a short distance beam. If it is determined in step S103 that the beam being processed is a short distance beam (beams 1 to 4, 10 to 13), the maximum range gate number for processing is set to 10 that corresponds to the boundary between the short distance region and the long distance region in step s104. On the other hand, if it is determined in step S103 that the beam is not a short distance beam (beams 5 to 9), the maximum range gate number for processing is set to 20 in step S105.

Then, in step S106, the target object is detected starting from the range gate number 1. It is determined in step S108 whether the processing has been completed to the maximum range gate set in step S104 or S105. If the completion is determined, the process proceeds to the next beam, and therefore the processing beam number is incremented in step S109. On the other hand, if the processing has not been completed, the process returns to step S106, the target object is detected at the next range gate and the relative position/the relative speed is calculated.

After the processing beam number is incremented in step S109, if it is determined in step S110 that the processing beam number is smaller than 13, the process returns to step S103 and the above-described processing is continued. On the other hand, if the processing beam number is not less than 13, the processing ends.

By the above-described signal processing, the detection angle range can be changed between the short distance region and the long distance region, so that the detection angle range can be narrower in the long distance region than in the short distance region.

According to the first embodiment, beams to be used to detect the target object are selected depending on the distance, and therefore the detection angle range for the target object can be changed between the short distance region and the long distance region in a single radar device by itself without changing the hardware structure. Therefore, the detection range for the target object can be formed in a necessary region in controlling the vehicle, so that unnecessary signal processing can be saved. According to the first embodiment, with the short distance beams 1 to 4 and 10 to 13 for example, processing is carried out to only the range gates 1 to 10 among all the 20 range gates, and therefore the amount of signal processing is halved as compared to the case of processing carried out to all the range gates, and the signal processing amount can be reduced by about 30% altogether.

The system can be implemented simply by software, and therefore the detection angle range can readily be changed, so that the detection range can be formed as desired depending on the number of lanes or the curvature of the curves of the road on which the vehicle travels. Furthermore, the mode does not have to be switched between the short distance measurement and the long distance measurement, and therefore a target object existing at a short distance and a target object existing at a long distance can be detected simultaneously without time difference.

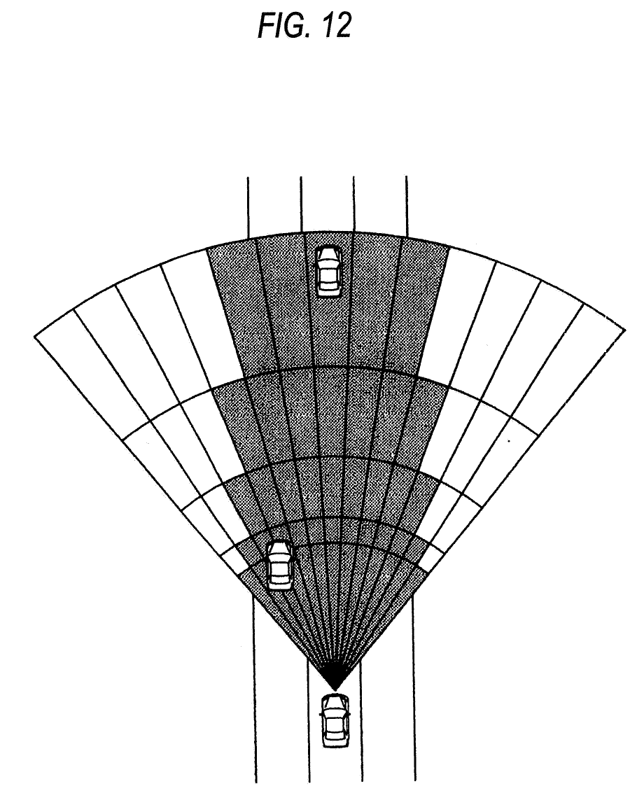

According to the first embodiment, the detection range is divided into the two regions, the short distance region and the long distance region, but the range may be divided into a larger number as shown in FIG. 12. If, for example, the detection angle is changed for each range gate, an even more appropriate detection region can be formed.

According to the first embodiment, using the lens and the plurality of antennas, the beams are formed in the plurality of directions, while the beams may be formed in other manners. If for example an antenna is driven by a motor, mechanical scanning with beams may be carried out, and still the same advantages can be obtained. Alternatively, electron beam scanning may be carried out, for example, by DBF.

### Second Embodiment

When a vehicle is stopped or travels at low speed, the vehicle control is mainly carried out to vehicles in the short distance and not to vehicles in the long distance. Therefore, vehicles in the long distance do not have to be detected. Therefore, if the vehicle is stopped or travels at low speed, target objects in the long distance are not detected and only those in the short distance are detected.

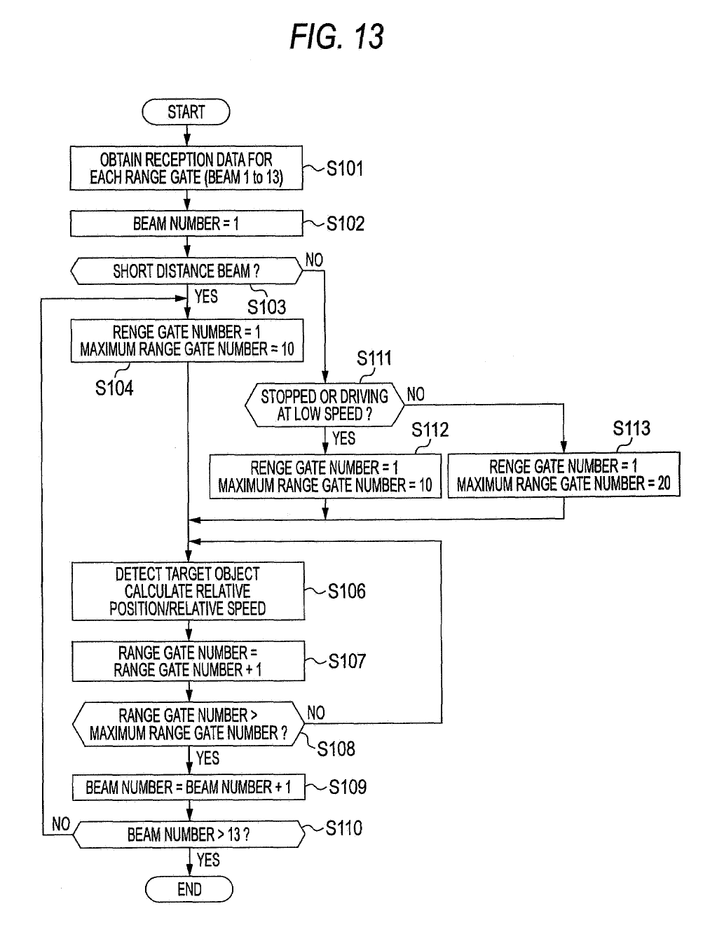

Now, the processing will be described with reference to the flowchart in FIG. 13. Steps 101 to 104 and 106 to 110 are the same as those in FIG. 13.

If it is determined in step S103 that the beam being processed is not a short distance beam, it is determined in step S111 whether the vehicle is stopped or travels at low speed. If it is determined in step S111 that the vehicle is stopped or travels at low speed, the maximum range gate number for processing is set to 10 in step S112 and in the following processing from steps S106 to S108, detection processing to target objects is not carried out in a long distance region having at least 11 range gates. On the other hand, if it is determined that the vehicle is neither stopped nor travels at low speed, the maximum range gate number for processing is set to 20 in step S113, and processing is to be carried out at all the range gates in the processing from steps S106 to S108.

According to the second embodiment, if the vehicle is stopped or travels at low speed, the long distance measurement is not carried out and therefore the amount of signal processing can be reduced.

### Third Embodiment

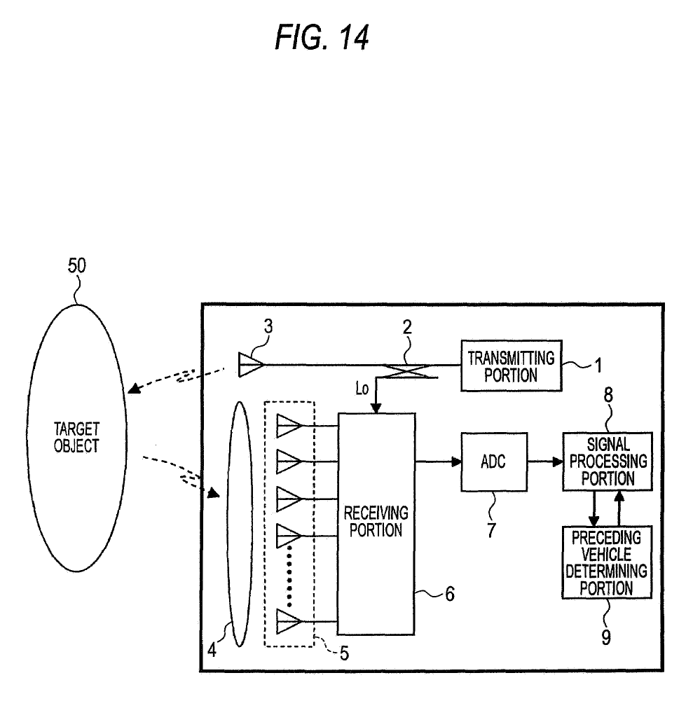

A radar device according to a third embodiment includes a preceding vehicle determining portion 9 that determines a preceding vehicle among detected target objects as shown in FIG. 14. The vehicle control, for example, in a following distance control system is generally carried out to the nearest preceding vehicle, and therefore data about vehicles existing ahead of the preceding vehicle is not used in the control. Therefore, in the long distance region ahead of the preceding vehicle detected by the preceding vehicle determining portion 9, target objects are not detected. In the short distance behind the preceding vehicle, the detection angle range may be widened so that vehicles coming to cut in can be surely detected.

Note that the preceding vehicle determining portion as described above is disclosed for example by JP-A-8-279099.

According to the third embodiment, detection of target objects is not carried out in the long distance ahead of the preceding vehicle, and therefore the signal processing amount can be reduced similarly to the second embodiment. In the short distance behind the preceding vehicle, if the detection angle range is widened, vehicles coming to cut in can surely be detected.

Various modifications and alterations of the present invention will be apparent to those skilled in the art without departing from the scope and spirit of the invention, and it should be understood that this is not limited to the illustrative embodiments set forth herein.

What is claimed is:

1. A radar device provided in a vehicle to detect a target object existing around the vehicle, comprising:
transmitting means for transmitting an electromagnetic wave as a transmission signal;
receiving means for receiving the electromagnetic wave reflected from said target object as a reception signal; and
signal processing means for detecting said target object based on said transmission signal and said reception signal and measuring the relative position and the relative speed between the vehicle and the object,
said radar device changing the detection angle range for said target object depending on the distance from the vehicle by said signal processing means without changing said transmitting means and said receiving means.

2. The radar device according to claim 1, wherein said radar device forms reception beams in a plurality of directions, and the detection angle range for said target object is changed by changing the number of beams used for measurement depending on the distance from the vehicle.

3. A radar device provided in a vehicle to detect a target object existing around the vehicle in a prescribed detection angle range, comprising:
transmitting means for transmitting an electromagnetic wave as a transmission signal;
receiving means for receiving the electromagnetic wave reflected by said target object as a reception signal by the plurality of reception beams corresponding to said prescribed detection angle range; and
signal processing means for producing a beat signal from part of said reception signal and said transmission signal, detecting the beat signal at a plurality of range gates set corresponding to prescribed sampling intervals, and measuring the relative position and the relative speed between said target object and the vehicle,
the signal processing means obtaining reception data corresponding to said plurality of reception beams for each said range gate and controlling said detection angle range depending on the distance to said target object based on the reception data for each said range gate and the relative relation with each said range gate.

4. The radar device according to claim 3, wherein the detection angle range for said target object is widened for short distance measurement and narrowed for long distance measurement.

5. The radar device according to claim 3, wherein when the vehicle is stopped or travels at low speed, only a target object existing in a prescribed distance or less is detected without detecting a target object existing ahead by more than the prescribed distance.

6. The radar device according to claim 3, further comprising preceding vehicle determining means for determining a preceding vehicle among said detected target objects, and in a long distance ahead of the preceding vehicle determined by said preceding vehicle determining means, detection of said target object is not carried out.

7. The radar device according to claim 3, wherein in a short distance behind the preceding vehicle determined by said preceding vehicle determining means, the detection angle range for said target object is widened.
